(19) United States
(12) Patent Application Publication
(10) Pub. No.: US 2024/0241263 A1
(43) Pub. Date: Jul. 18, 2024

(54) LOW-EARTH ORBIT (LEO) SATELLITE POSITION, VELOCITY, AND TIME (PVT) DETERMINATION FOR LEO-BASED POSITIONING

(71) Applicant: QUALCOMM Incorporated, San Diego, CA (US)

(72) Inventors: Ning LUO, Cupertino, CA (US); Yuxiang PENG, Sunnyvale, CA (US); Han ZHANG, Beijing (CN); Yinghua YANG, San Jose, CA (US); Bo ZHENG, Sunnyvale, CA (US); Min WANG, Tustin, CA (US)

(21) Appl. No.: 18/559,533

(22) PCT Filed: Jul. 15, 2021
(86) PCT No.: PCT/CN2021/106419

§ 371 Date: Nov. 7, 2023

(51) Int. Cl. G01S 19/01; G01S 5/00

(52) U.S. Cl. CPC G01S 19/01; G01S 5/0027

(57) ABSTRACT

Position, Velocity, and Time (PVT) information of a LEO satellite can be determined by leveraging a known position of a mobile device comprising a terrestrial satellite receiver of the LEO satellite and using range information (range and/or range rate) of the LEO satellite taken at the mobile device. According to some embodiments, this PVT information can be shared by the mobile device with the server and/or other mobile devices, and information from multiple mobile devices can be crowdsourced to determine robust PVT information for a LEO satellite. Once the PVT information is determined, it can be used to subsequently for positioning of the mobile device and/or other mobile devices.

### BACKGROUND

### 1. Field of Disclosure

The present disclosure relates generally to the field of satellite-based positioning.

### 2. Description of Related Art

Global Navigation Satellite Systems (GNSS) positioning of mobile devices (e.g., consumer electronics, vehicles, assets, drones, etc.) can provide accurate positioning of a GNSS receiver in open sky scenarios. However, because GNSS satellites are distant compared with other satellites, their signals are relatively weak, and they move relatively slowly across the sky. This can make GNSS-based positioning more susceptible to degradation due to blockage if large parts of the sky are obstructed. They may also be more susceptible to spoofing, where a false signal may be stronger than the relatively weak GNSS signal. Solutions for using Low-Earth Orbit (LEO) satellites for positioning thus far have often required additional hardware on the LEO satellites.

### BRIEF SUMMARY

Embodiments described herein provide for determining Position, Velocity, and Time (PVT) information of a LEO satellite by leveraging a known position of a mobile device comprising a terrestrial satellite receiver of the LEO satellite and using ranging measurements (e.g., range and/or range rate) of the LEO satellite taken at the mobile device. According to some embodiments, this PVT information can be shared by the mobile device with the server and/or other mobile devices, and information from multiple mobile devices can be crowdsourced to determine robust PVT information for a LEO satellite. Once the PVT information is determined, it can be used to subsequently for positioning of the mobile device and/or other mobile devices.

An example method of determining Position, Velocity, and Time (PVT) information of a Low-Earth Orbit (LEO) satellite for LEO-based positioning, according to this disclosure, comprises obtaining a known position of a mobile device comprising a LEO receiver. The method also comprises obtaining range information indicative of a range between the mobile device and the LEO satellite, the range information obtained from one or more measurements of a radio frequency (RF) signal transmitted by the LEO satellite and received by the LEO receiver of the mobile device. The method also comprises determining the PVT information of the LEO satellite based at least in part on the known position of the mobile device and the range information.

An example device for determining Position, Velocity, and Time (PVT) information of a Low-Earth Orbit (LEO) satellite for LEO-based positioning, according to this disclosure, comprises a transceiver, a memory, one or more processors communicatively coupled with the transceiver and the memory, wherein the one or more processors are configured to obtain a known position of a mobile device comprising a LEO receiver. The one or more processing units are further configured to obtain range information indicative of a range between the mobile device and the LEO satellite, the range information obtained from one or more measurements of a radio frequency (RF) signal transmitted by the LEO satellite and received by the LEO receiver of the mobile device. The one or more processing units are further configured to determine the PVT information of the LEO satellite based at least in part on the known position of the mobile device and the range information.

An example apparatus for determining Position, Velocity, and Time (PVT) information of a Low-Earth Orbit (LEO) satellite for LEO-based positioning, according to this disclosure, comprises means for obtaining a known position of a mobile device comprising a LEO receiver. The apparatus further comprises means for obtaining range information indicative of a range between the mobile device and the LEO satellite, the range information obtained from one or more measurements of a radio frequency (RF) signal transmitted by the LEO satellite and received by the LEO receiver of the mobile device. The apparatus further comprises means for determining the PVT information of the LEO satellite based at least in part on the known position of the mobile device and the range information.

According to this disclosure, an example non-transitory computer-readable medium stores instructions for determining Position, Velocity, and Time (PVT) information of a Low-Earth Orbit (LEO) satellite for LEO-based positioning, the instructions comprising code for obtaining a known position of a mobile device comprising a LEO receiver. The instructions further comprise code for obtaining range information indicative of a range between the mobile device and the LEO satellite, the range information obtained from one or more measurements of a radio frequency (RF) signal transmitted by the LEO satellite and received by the LEO receiver of the mobile device. The instructions further comprise code for determining the PVT information of the LEO satellite based at least in part on the known position of the mobile device and the range information.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified diagram of a GNSS system, according to an embodiment.

FIG. 2 is a cross-sectional diagram of a portion of the earth and orbits of Global Navigation Satellite Systems (GNSS) satellites and Low-Earth Orbit (LEO) satellites.

FIG. 3 is a simplified diagram provided to help illustrate a Position, Velocity, and Time (PVT) determination process, according to an embodiment.

FIGS. 4A and 4B are a block diagrams illustrating how measurements and communication may be shared in different environments.

FIG. 5 is a flow diagram of a method of determining PVT information of an LEO satellite for LEO-based positioning, according to an embodiment.

FIG. 6 is a block diagram of an embodiment of a mobile device, which can be utilized in embodiments as described herein.

FIG. 7 is a block diagram of an embodiment of a computer system, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used, and various modifications may be made without departing from the scope of the disclosure or the spirit of the appended claims.

As described herein, a satellite receiver, such as a Global Navigation Satellite Systems (GNSS) and/or Low-Earth Orbit (LEO) satellite receiver, may be integrated into a mobile device comprising an electronic device or system. Such a mobile device can include, for example, consumer, industrial, and/or commercial electronics, vehicles, assets, vessels, and the like. As described herein, a location estimate of the satellite receiver or mobile device into which the satellite receiver is integrated may be referred to as a location, location estimate, location fix, fix, position, position estimate, or position fix of the satellite receiver or mobile device. Moreover, the location estimate may be geodetic, thus providing location coordinates for the mobile device (e.g., latitude and longitude) which may or may not include an altitude component (e.g., height above sea level, height above or depth below ground level, floor level, or basement level). In some embodiments, a location of the satellite receiver and/or mobile device comprising the satellite receiver may also be expressed as an area or volume (defined either geodetically or in civic form) within which the satellite receiver is expected to be located with some probability or confidence level (e.g., 67%, 95%, etc.). In the description contained herein, the use of the term location may comprise any of these variants unless indicated otherwise. When computing the location of a satellite receiver, such computations may solve for local X, Y, and possibly Z coordinates and then, if needed, convert the coordinates from one coordinate frame to another.

As noted, embodiments described herein provide for determining Position, Velocity, and Time (PVT) information of a LEO satellite by leveraging a known position of a mobile device comprising a terrestrial satellite receiver of the LEO satellite and using ranging measurements (e.g., range and/or range rate) of the LEO satellite taken at the mobile device. According to some embodiments, this PVT information can be shared by the mobile device with the server and/or other mobile devices, and information from multiple mobile devices can be crowdsourced to determine robust PVT information for a LEO satellite. Once the PVT information is determined, it can be used to subsequently for positioning of the mobile device and/or other mobile devices. Additional details will follow after an initial description of relevant systems and technologies.

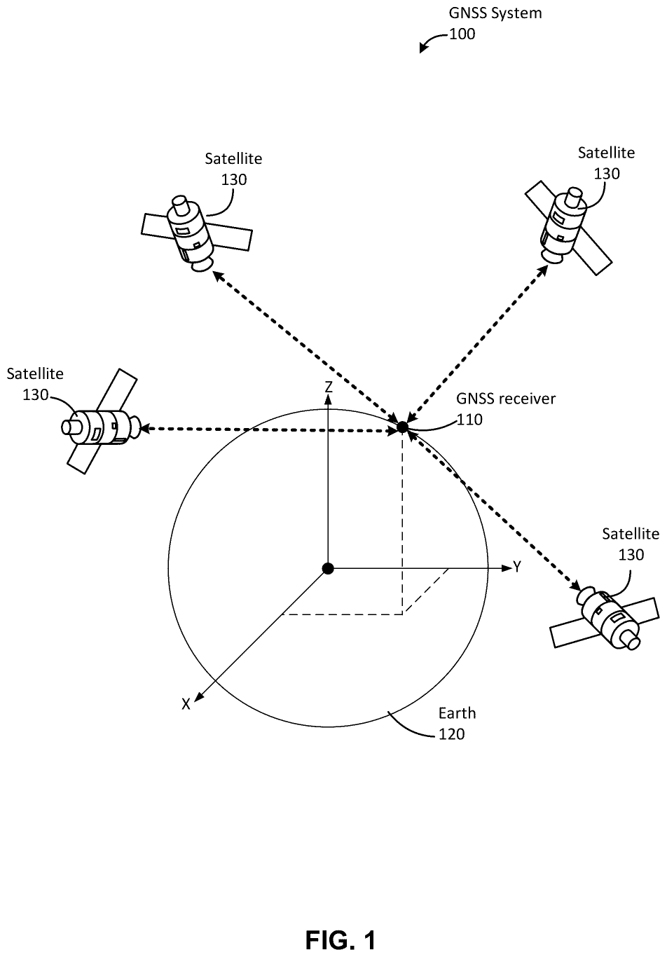

FIG. 1 is a simplified diagram of a GNSS system 100, provided to illustrate how GNSS is generally used to determine an accurate location of a GNSS receiver 110 on earth 120 (also known as “positioning” of the GNSS receiver). Put generally, the GNSS system 100 enables an accurate GNSS position fix of the GNSS receiver 110, which receives radio frequency (RF) signals from GNSS satellites 130 from one or more GNSS constellations. The types of GNSS receiver 110 used may vary, depending on application. In some embodiments, for instance, the GNSS receiver 110 may comprise consumer electronics or devices, such as a mobile phone, tablet, laptop, wearable device, vehicle (or on-vehicle device), or the like. In some embodiments, the GNSS receiver 110 may comprise industrial or commercial equipment, such as survey equipment.

It will be understood that the diagram provided in FIG. 1 is greatly simplified. In practice, there may be dozens of satellites 130 and a given GNSS constellation, and there are many different types of GNSS systems. GNSS systems include, for example, Global Positioning System (GPS), Galileo, GLONASS, Quasi-Zenith Satellite System (QZSS) over Japan, Indian Regional Navigational Satellite System (IRNSS) over India, BeiDou Navigation Satellite System (BDS) over China, and/or the like. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration, which is a method of determining position by measuring distances to points at known coordinates. In general, the determination of the position of a GNSS receiver 110 in three dimensions may rely on a determination of the distance between the GNSS receiver 110 and four or more satellites 130. As illustrated, 3D coordinates may be based on a coordinate system (e.g., XYZ coordinates; latitude, longitude, and altitude; etc.) centered at the earth's center of mass. A distance between each satellite 130 and the GNSS receiver 110 may be determined using precise measurements made by the GNSS receiver 110 of a difference in time from when a radio frequency (RF) signal is transmitted from the respective satellite 130 and when it is received at the GNSS receiver 110. To help ensure accuracy, not only does the GNSS receiver 110 need to make an accurate determination of when the respective signal from each satellite 130 is received, but many additional factors need to be considered and accounted for. These factors include, for example, clock differences at the GNSS receiver 110 and satellite 130 (e.g., clock bias), a precise location of each satellite 130 at the time of transmission (e.g., as determined by the broadcast ephemeris), the impact of atmospheric distortion (e.g., ionospheric and tropospheric delays), and the like.

To perform a traditional GNSS position fix, the GNSS receiver 110 can use code-based positioning to determine its distance to each satellite 130 based on a determined delay in a generated pseudorandom binary sequence received in the RF signals received from each satellite, in consideration of the additional factors and error sources previously noted. With the distance and location information of the satellites 130, the GNSS receiver 110 can then determine a position fix for its location. This position fix may be determined, for example, by a Standalone Positioning Engine (SPE) executed by one or more processors of the GNSS receiver 110. However, code-based positioning is relatively inaccurate and, without error correction, and is subject to many of the previously described errors. Even so, code-based GNSS positioning can provide an positioning accuracy for the GNSS receiver 110 on the order of meters.

More accurate carrier-based range estimation is based on a carrier wave of the RF signals from satellites and may use measurements at a base or reference station (not shown) to perform error correction to help reduce errors from the previously noted error sources. More specifically, errors (e.g., atmospheric errors sources) in the carrier-based range estimate of satellites 130 observed by the GNSS receiver 110 can be mitigated or canceled based on similar carrier-based range estimation of the satellites 130 using a highly accurate GNSS receiver at the base station at a known location. These measurements and the base station's location can be provided to the GNSS receiver 110 for error correction. This position fix may be determined, for example, by a Precise Positioning Engine (PPE) executed by one or more processors of the GNSS receiver 110. More specifically, in addition to the information provided to an SPE, the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters).

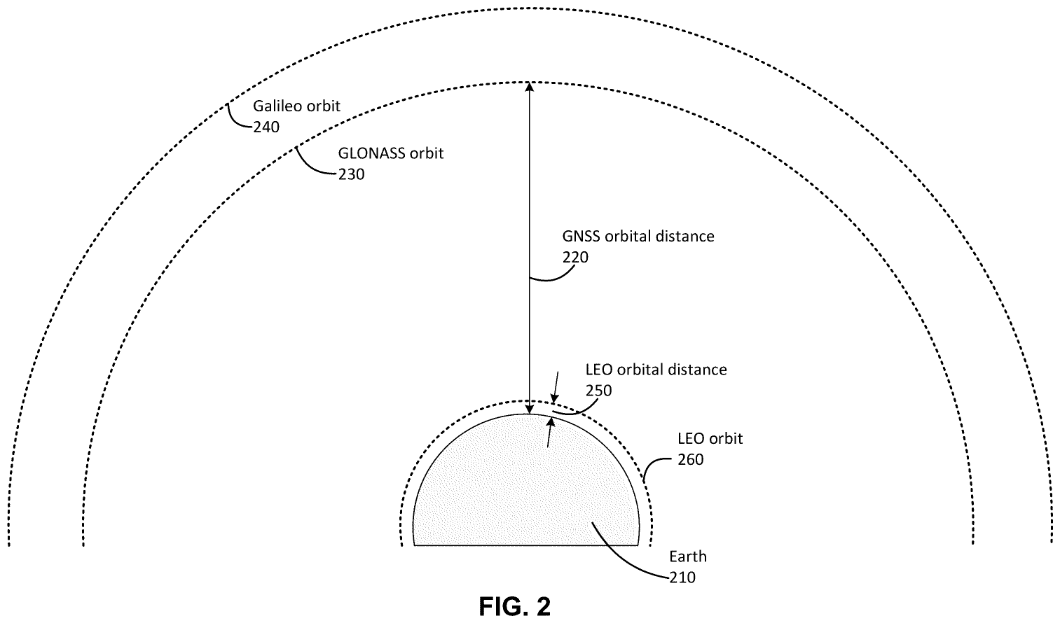

While positioning provided by GNSS satellites using these techniques often can be accurate and reliable, it may have its drawbacks relative to LEO satellites. Additional detail regarding GNSS satellites and LEO satellites is provided with regard to FIG. 2.

FIG. 2 is a simplified cross-sectional diagram of a portion of the earth 210 and orbits of GNSS satellites and LEO satellites, illustrating relative distances between LEO satellites and GNSS satellites. Two example GNSS systems (GLONASS and Galileo) are illustrated, but other GNSS systems (not shown) have similar orbital distances.

Generally put, orbital distance 220 of GNSS systems are approximately 20,000 km. More specifically, the satellite orbits of GNSS systems range between 19130 km (GLONASS orbit 230) and 23222 km (Galileo orbit 240). At this altitude, satellites orbit the earth 210 on the order of approximately 11 to 14 hours, and atmospheric effects on satellite orbit are typically negligible.

The LEO orbital distance 250 of an LEO satellite in LEO orbit 260, on the other hand, is roughly 10 times closer. That is, LEO orbital distance 250 is below approximately 2,000 km. At this altitude, satellites may orbit the earth 210 in fewer than 128 minutes. In addition to the International space Station (ISS), Hubble space telescope, and other satellites supported by militaries, governments, national agencies, and/or international agencies, LEO satellites may also comprise commercial satellites. These commercial satellites may, for example, support telecom applications (e.g., satellite-based Internet and radio), imaging, and the like.

Although GNSS satellites are typically used for positioning, LEO satellites may offer some advantages over traditional GNSS positioning. Given the proximity of LEO satellites, they may be capable of sending much stronger signals (e.g., 30 dB stronger than GNSS), which may allow for easier detection of signals by satellite receivers, and less vulnerability to spoofing and jamming. The speed at which LEO satellites orbit the earth 210 also provides for faster changing geometry (approximately 15 times faster), which can lead to more resistance to multipath errors and can be beneficial in integer carrier phase ambiguity resolution.

Despite those advantages, there are drawbacks for using LEO satellites for positioning. For example, satellite position information for LEO satellites, such as ephemerides (meter-level accurate satellite position and clock) typically are not available. This is because LEO satellites are typically not designed for positioning, thus, an accurate timing source (e.g., an atomic clock) is unnecessary, and there may be no ground control segment (GCS) needed to provide ephemeris and almanac. Thus, without accurate PVT information of LEO satellites, it can be difficult to perform positioning of terrestrial-based devices (e.g., mobile devices) using measurements of signals from LEO satellites with an accuracy or robustness similar to GNSS positioning.

Some solutions may comprise equipping an LEO satellite with the GNSS receiver, enabling the LEO satellite to determine its location using GNSS signals from GNSS satellites. But this, too, has its drawbacks. For example, this solution would necessarily exclude any existing LEO satellites that do not already have GNSS receivers. Further, equipping new LEO satellites with GNSS receivers mean additional payload and power consumption, which can be especially impactful for smaller LEO satellites.

Embodiments herein address these and other issues by determining accurate PVT information of an LEO satellite using a terrestrial satellite receiver at a known position. In particular, a terrestrial device, such as a mobile device, may be able to determine its position using positioning techniques such as GNSS, network-based positioning techniques (e.g., positioning performance by mobile broadband and/or wireless local area network (WLAN) networks), or the like. The terrestrial satellite receiver can then measure signals from the LEO satellite to determine a range and trajectory of the LEO satellite, and derived PVT information of the LEO satellite based on the measurements and the known position of the terrestrial satellite receiver. The PVT information may then be shared with other devices (e.g., other mobile devices, a server, etc.), and used for positioning of mobile devices.

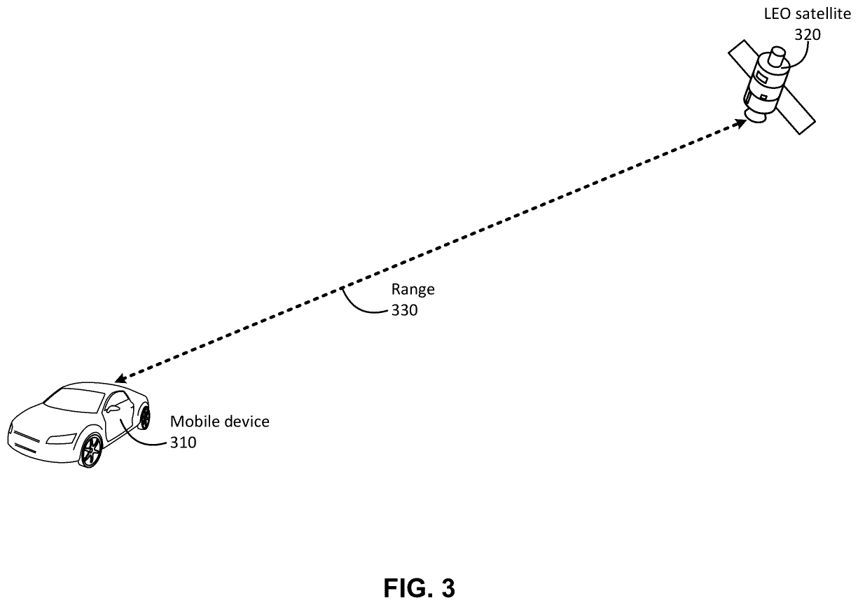

FIG. 3 is a simplified diagram provided to help illustrate the PVT determination process, according to some embodiments, in more detail. The diagram illustrates a mobile device 310 comprising a satellite receiver receiving signals from an LEO satellite 320. A distance between the mobile device 310 and LEO satellite 320 is shown as range 330. This range 330 varies over time as the satellite orbits the earth, and may be dependent on altitude (e.g. 2,000 km or less) of the LEO satellite 320 and angle of the LEO satellite 320 relative to the mobile device 310 (e.g., with relation to a horizontal plane).

It can be noted that although a single mobile device 310 and single LEO satellite 320 are illustrated in FIG. 3 for illustrative purposes, embodiments are not so limited. An LEO satellite 320 may send signals (e.g., broadcast RF signals) to many devices comprising satellite receivers (e.g., tens, hundreds, thousands, or more). Likewise, the mobile device 310 may receive signals from many LEO satellites 320. Moreover, according to some embodiments, the mobile device 310 may be capable of receiving signals from two or more LEO satellites of different constellation and/or different types using, for example, multiple satellite receivers and/or multi-frequency/multi-constellation receivers. Thus, a mobile device 310 may be capable of performing the techniques for determining PVT information of an LEO satellite 320 described herein for multiple LEO satellites at a time.

Further, in the example illustrated in FIG. 3, the mobile device 310 is illustrated as being a vehicle, but embodiments are not so limited. As previously noted, a satellite receiver may comprise and/or be integrated into various different types of devices, vehicles, etc. This can include consumer electronics (e.g., mobile phones, consumer navigation equipment, etc.) vehicles and vessels (e.g., automobiles, ships, boats, planes, etc.); drones, robotic equipment, and/or other automated devices; commercial and/or military assets (e.g., shipping containers, military and/or industrial equipment, etc.); and the like. Further, techniques described herein are not limited to mobile devices, but may additionally or alternatively use static or immobile devices with known or determinable locations. Moreover, a single LEO satellite 320 may communicate with mobile devices 310 of many types.

To determine the PVT information of the LEO satellite 320, the mobile device 310 can have (1) capability of determining its position, and (2) capability of performing measurements to determine the range 330. As previously noted, the position of the mobile device 310 can be determined via one or more techniques including GNSS positioning (e.g., if the mobile device is equipped with a GNSS receiver), wireless network-based positioning (e.g., if the mobile device is equipped with an LTE, NR, and/or similar mobile communication receiver), sensor-based positioning, dead reckoning, or the like. As for determining range 330, any of a variety of techniques may be performed for generating pseudo-range between the LEO satellite 320 and mobile device 310. These techniques may be dependent, for example, on modulation and/or other properties of signals transmitted by the LEO satellite 320 and received by a mobile device 310. Additionally, range rates, or rates at which the range 330 changes over time, also may be determined from the frequency offset between the nominal frequency and the actual track frequency.

For example, according to some embodiments, an LEO satellite 320 may comprise a dedicated Positioning, Navigation, and Timing (PNT) service to facilitate range determination. This can include, for example, communications providing Satellite Time and Location (STL), which is deployed on Iridium and Iridium NEXT satellites. The process of generating pseudorange is similar to generating pseudo-range in GPS. In particular, the quadrature phase-shift keying (QPSK) transmission scheme used by such satellites can facilitate precision measurements by providing QPSK data at the beginning of an STL burst that may be manipulated to form a continuous wave (CW) marker used for burst detection and coarse measurement. The remaining QPSK data in the STL burst may then be organized into pseudorandom sequences. This can reduce the effective information data rate while providing a mechanism for precise measurement via correlation with locally generated sequences.

Embodiments may require very little to implement pseudo-range determination using this technique. Little or no additional hardware may be needed on the LEO satellite 320 to implement the STL communications to provide the PNT service, and a modernized GNSS receiver of the mobile device 310 may only need minor modification to generate pseudorange measurements from the LEO satellite signal.

Additionally or alternatively, measurements of the range 330 may be performed without a PNT service provided by the LEO satellite 320. For example, if the LEO satellite 320 transmits Code-division multiple access (CDMA) signals, or any other form of Direct-Sequence Spectrum Spread (DS-SS), a mobile device 310 may be able capture a pseudo-random-noise code (PRN code) and generate pseudoranges, as may be performed in GNSS to get high timing (ranging accuracy). The challenge is some modifications to the downlink protocol may be required to provide precise timing of the downlink signals. For example, “seconds in a week” (SOW) in a GPS sub-frame is the timing information embedded in GPS signals. An example modification to an LEO protocol may comprise adding a time stamp to a message transmitted by an LEO satellite (e.g., LEO satellite 320) in the downlink signals to a receiver (e.g., at mobile device 310) to provide something similar to SOW in GPS. Instead of SOW, the time stamp could be “milliseconds in an hour,” from which a receiver can easily derive the absolute full time. Other embodiments may use additional or alternative types of timestamps, depending on desired functionality.

PVT information of the LEO satellite 320 can be determined at the mobile device 310 (or, as explained below, a server or other device) using a positioning engine. In particular, a positioning engine comprising a Extended Kalman Filter (EKF) or Weighted Least Squares (WLS) algorithm can use information from the range measurements to determine PVT information of the LEO satellite 320. According to some embodiments, a course position of the LEO satellite 320 may be obtained from an almanac and used as a starting point for the positioning engine. Range measurements, including ranges and (if available) range rates), as well as the known position of the mobile device 310, can then be provided to the EKF/WLS algorithm to determine PVT information of the LEO satellite 320. (Additional details regarding a specific technique are provided hereafter.) According to some embodiments, 8-12 states may be needed to estimate PVT information of the LEO satellite 320, and thus PVT information can be determined in 12 epochs (measurement/estimation periods), or fewer if range rates are available. Similar to many GNSS applications, each epoch may be one second, thus a solution for the PVT information of the LEO satellite 320 may take as little as 6-12 seconds. That said, if more data is available (e.g., from other satellite receivers, as described in more detail below) PVT information may be determined in less time. On the other hand, more data may be collected over a longer period of time, according to some embodiments, to help ensure a robust determination of the PVT information. Determining PVT information of an LEO satellite 320 in this manner can often have an accuracy within a few meters. This can be input into a gravitational model, as explained in more detail below, to provide sufficient ephemeris for subsequent position determination based on the PVT information.

As previously indicated, range measurements and/or PVT information of the LEO satellite 320 may be used by the mobile device 310 and/or shared among other devices to enable subsequent positioning of the mobile device 310 and/or other devices using the LEO satellite 320. In a stand-alone mode, the mobile device 310 may determine PVT information of the LEO satellite 320 at a time during which the location of the mobile device 310 is known or can be determined using means other than the LEO satellite 320. For example, in a “GNSS benign” environment where GNSS positioning of the mobile device 310 is available, the mobile device 310 may determine its location and make range measurements (across 6-12 epochs, if needed, as previously described) to determine PVT information of the LEO satellite 320 at time T₀. At a subsequent time, T_{K}, in a GNSS denied or degraded environment when GNSS positioning is unavailable, the mobile device 310 can use a gravitational model (an example of which is described hereafter) and the previously-determined PVT information of the LEO satellite 320 to determine current PVT information for time TK. Together with new range of the LEO satellite 320 by the mobile device 310, the current PVT information of the LEO satellite 320 can be used to determine the position of the mobile device 310 at time TK.

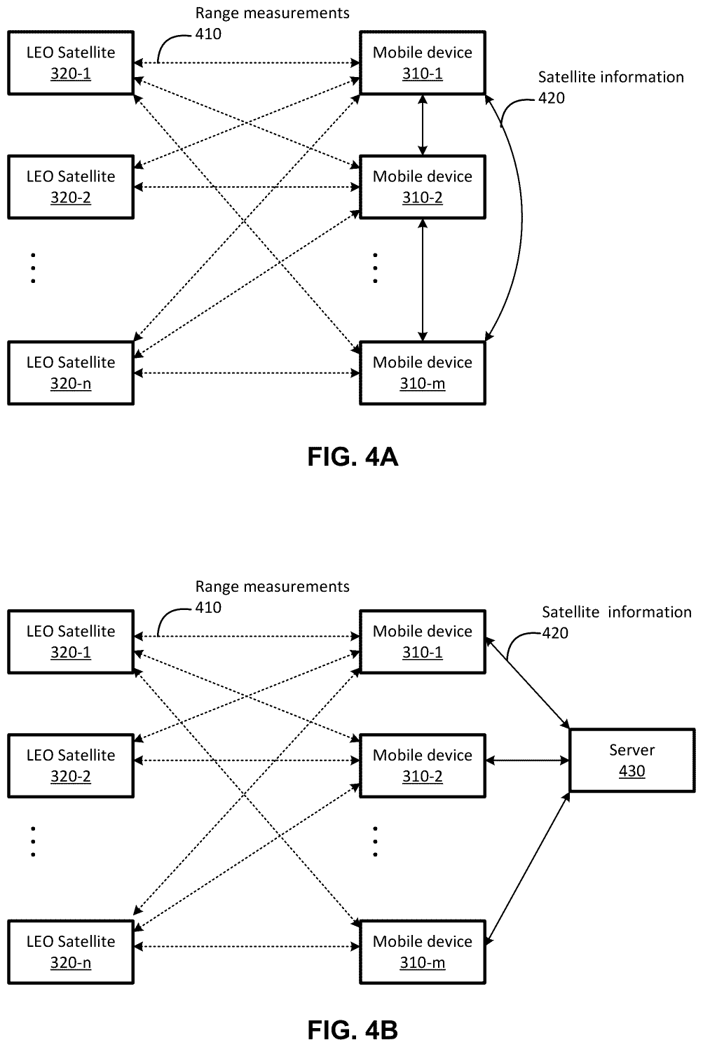

In a crowdsourcing mode, the mobile device 310 may share location information regarding the LEO satellite 320 with one or more devices. Examples of how this can be done are illustrated in FIGS. 4A and 4B.

FIG. 4A is a block diagram illustrating how measurements and communication may be performed in an ad-hoc or peer-to-peer (P2P) environment. In this example, a number, m, of mobile devices 310 take range measurements of each of a number, n, of LEO satellites 320. As previously indicated, any number of LEO satellites 320 and mobile devices 310 may be used, depending on desired functionality and situational circumstances. Thus, a smaller number of LEO satellites 320 and/or mobile devices 310 than illustrated in FIG. 4A may be used. Further, it can also be noted that the number, m, of mobile devices 310 may be equal to or different from the number, n, of LEO satellites 320.

As previously noted, 8-12 states may be needed to estimate PVT information of an LEO satellite 320. Although these states can be determined by a single mobile device 310 taking range measurements 410 across multiple epochs, the states may additionally or alternatively be determined by range measurements 410 taken by multiple mobile devices 310. Because multiple devices may take multiple range measurements 410 of an LEO satellite 320 in a single epoch, fewer epochs may be needed to estimate PVT information of the LEO satellite 320. A configuration in which 100 mobile devices (m=100) collectively take 100 measurements of a particular LEO satellite (e.g., LEO satellite 320-1) can result in enough information to determine the PVT information of the particular LEO satellite and a single epoch. As noted, a single mobile device 310 may take range measurements 410 of multiple LEO satellites 320 in parallel. Thus, as illustrated in FIG. 4A multiple mobile devices may take range measurements 410 of multiple LEO satellites resulting in multiple range measurements 410 of each LEO satellite 320 per epoch.

The satellite information 420 shared between mobile devices 310 may vary, depending on desired functionality, and may be shared in a variety of ways. The information itself may comprise one or more measurements and/or PVT information derived from the one or more measurements. The satellite information 420 may also include timestamp information. For example, for satellite information 420 comprising one or more measurements, it may also include one or more respective timestamps indicative of when the one or more measurements were taken. For satellite information 420 comprising PVT information, such as a model describing the PVT of the LEO satellite, the satellite information 420 can include a timestamp indicating when the PVT information was determined, a duration of time during which the PVT information is valid, and/or a time at which the PVT information expires. Because the timestamps for satellite information 420 are not used themselves for the determination of the mobile device location, they do not need to be in precise synchronization (e.g., between mobile device 310 and LEO satellite 320) for accurate position determination. Instead, because timestamps are used to determine when information is valid (which, as described herein, can span seconds, minutes, or longer), synchronization on the order of tens of nanoseconds or greater may be sufficient to utilize the satellite information 420.

In the ad-hoc or P2P environment of FIG. 4A, information may be shared using direct and/or indirect communications from one mobile device 310 to another. Indirect communication may comprise communication relayed from one mobile device 310 to another via one or more intermediary devices or components. This communication may include a wireless network (e.g., a wide area network (WAN), local area network (LAN), mobile broadband or cellular network, etc.) and may include one or more additional public and/or private networks (e.g., the Internet). Direct communication between mobile devices 310 may be dependent on communication capabilities of the mobile devices 310. Direct wireless communication, for example, may use 5G, Wi-Fi, and/or other wireless standards that define Device-to-Device (D2D) communication technologies. This may include, for example, Sidelink, which is a form of D2D communication defined by 3GPP under the cellular-based LTE and NR standards.

FIG. 4B is a block diagram illustrating how measurements and communication may be performed in a server-based environment. Similar to the example of FIG. 4A, m mobile devices 310 take range measurements of each of n of LEO satellites 320. Here, however, satellite information 420 is provided by mobile devices 310 to a server 430. This can be via any form of communication between the mobile device 310 and server 430, including wireless and/or wired technologies, private and/or public networks (e.g., 5G, Wi-Fi, cellular, the Internet, etc.) According to some embodiments, the server can gather the satellite information 420 from the mobile devices 310, calculate accurate measurement and/or PVT information from the gathered information, and circulate the calculated measurement and/or PVT information to the mobile devices 310. This calculated information can be sent back to mobile devices 310 from a server 430. Additionally or alternatively, the server 430 may provide calculated information to the LEO satellite 320, which may then broadcast the calculated information to the mobile devices 310.

It can be noted that other configurations different from those illustrated in FIGS. 4A and 4B can be made, depending on desired functionality. For example, some configurations may use an ad-hoc or P2P environment as shown in FIG. 4A simultaneously with a server 430 as shown in FIG. 4B. Additionally or alternatively, some embodiments may provide satellite information 420 to one or more mobile devices that do not also take range measurements 410.

The sharing of satellite information 420 using either or both of the configurations illustrated in FIGS. 4A and 4B can include improved performance, robustness, and accuracy, in addition to the advantage of providing faster solutions as previously described. For example, a mobile device 310 or server 430 may receive satellite information 420 from multiple mobile devices 310 an process the received satellite information 420 to provide robustness. This can include, for example, averaging values, weighting values (e.g. based on confidence metrics, accuracy metrics, etc.), selecting certain values, performing outlier detection/removal, and/or the like. According to some embodiments, a server 430 may perform additional processing (relative to a mobile device 310) to generate PVT information using a better model than a mobile device, allowing a higher longer period of the PVT information. The server 430 can, for example, generate a model for the PVT information that lasts tens of minutes to cover the whole satellite visible period, which can reduce the number of downloads to various mobile devices 310.

The sharing of satellite information 420 (including range measurements 410 and/or information derived therefrom) may be performed in different ways. This may include a “push” or “pull” method, in which satellite information can be “pushed” out to other devices without a request, or “pulled” from other devices in response to a request.

For example, according to some embodiments, satellite information 420 may be broadcast. As previously noted, it may be broadcast by the LEO satellite 320 itself. According to some embodiments, for example, a LEO satellite 320 may broadcast satellite information 420 for itself (and/or possibly other LEO satellites 320) periodically (e.g., every few seconds, minutes, etc.). Additionally or alternatively, mobile devices 310 may broadcast this information to nearby devices. According to some embodiments, satellite information 420 may be broadcast by certain network entities (e.g., access points, base stations, etc.) of a wireless network. According to some embodiments, such broadcasts may be encrypted to help ensure security of the information.

According to some embodiments, the sharing of satellite information 420 may be conducted on demand. For example, a first mobile device 310-1 may send satellite information 420 to a second mobile device 310-2 or server 430 in response to a request for the satellite information 420 from the second mobile device 310-2 or server 430. Where uplink communication to an LEO satellite 320 is possible, a mobile device 310 may request satellite information 420 from an LEO satellite 320. In some embodiments, this may be executed by the mobile device 310 sending a request to the server 430, which can (via an uplink to the LEO satellite 320) relay the request to the LEO satellite 320. Embodiments that use on-demand sharing in this manner can utilize bandwidth more efficiently, providing satellite information 420 only in certain circumstances (e.g., when a mobile device 310 is in a GNSS degraded/denied environment).

According to some embodiments, to further preserve or reduce bandwidth utilized by sharing satellite information 420, and reduce the processing load of receiving devices for decoding shared satellite information 420, the satellite information 420 requested by the requesting mobile device 310 may comprise satellite information 420 only for LEO satellites 320 visible to the requesting mobile device 310. This can include, for example, an indication of the LEO satellites 320 visible to the requesting mobile device 310 (e.g., based on RF signals of the LEO satellites 320 received by the requesting mobile device 310). Additionally or alternatively, this can include an indication of an approximate position of the requesting mobile device 310, in which case the responding device or server that receives the request can determine, based on almanac or other information, which LEO satellites 320 should be visible to the requesting mobile device 310.

As noted, PVT information for an LEO satellite can be determined from range measurements and may be represented in different ways. As previously mentioned, PVT information may be obtained using 8-12 states, for example. An 8-state example may include three satellite position components, three satellite velocity components, and two clock components (e.g., clock bias and clock drift). The overall clock error, then, may be described as a first order polynomial:

Clock error=Clock bias+Clock drift*Δ_{T}, (1)

where Δ_{T} is a time period over which the clock drift occurs.

The way in which the position and velocity (PV) information is represented may vary and may further impact the length of time for which the PVT information is valid. For example, according to some embodiments, PV information of an LEO satellite may be represented using a Keplerian model. A Keplerian model, which is traditionally used to model Geosynchronous Equatorial Orbit (GEO) and Medium Earth Orbit (MEO) satellites, can be used for LEO satellites as well. It offers efficient compression, for example, and can be used for an extended period of time (e.g., 1-4 hours). As a person of ordinary skill in the art will appreciate, a Keplerian model can contain 6-20 parameters or more, depending on its validity period and expected accuracy. For example GPS has 16-parameter Keplerian model. The simplest Keplerian model can only have 6 parameters, e.g. semi-major, eccentricity, inclination, etc. The advantages of using a Keplerian model may be weighed against disadvantages for using a Keplerian model for LEO satellite, such as the relatively computationally heavy calculations (e.g., large amount of trigonometric calculations) versus other representations. Further, Keplerian modeling, while accurate for MEO and LEO satellite orbits may be less accurate for LEO satellites, which experience relatively more complicated gravitational perturbations and atmospheric drag.

According to some embodiments, a direct Position and Velocity (PV) may offer some additional advantages. While a direct PV representation may be valid for a shorter time than a Keplerian representation (e.g., on the order of seconds to minutes, rather than hours), it can offer a relatively lighter computational load using numerical integration with fewer parameters. This can be beneficial for certain types of devices, such as connected mobile devices, which may benefit from a lighter computational load (e.g., from a power consumption and/or processing resource perspective) and are capable of receiving updated PV information on the order of seconds to minutes.

According to some embodiments, PVT information of an LEO satellite can be modeled based on position and velocity information measured by a mobile device. In an example 3D measurements of position (x, y, z) and velocity (Vₓ, V_{y}, V_{z}) may be obtained by a mobile device at time T0. Changes to position of the LEO satellite in each dimension (x, y, z) over time can then be modeled as:

$$\frac{dx}{dt} = {V}_{x} , \qquad ( 2 )$$

$$\frac{dy}{dt} = {V}_{y} ,$$

$$and$$

$$\frac{dz}{dt} = {V}_{z} .$$

Further, changes to velocity of the LEO satellite over time can then be modeled as:

$$\frac{{dV}_{x}}{dt} = \frac{- μ}{{r}^{3}} x - \frac{3}{2} {J}_{0}^{2} \frac{μ {a}^{2}}{{r}^{5}} x ( 1 - \frac{5 {z}^{2}}{{r}^{2}} ) + {ω}^{2} x + 2 ω {V}_{y} , \qquad ( 3 )$$

$$\frac{{dV}_{y}}{dt} = \frac{- μ}{{r}^{3}} y - \frac{3}{2} {J}_{0}^{2} \frac{μ {a}^{2}}{{r}^{5}} y ( 1 - \frac{5 {z}^{2}}{{r}^{2}} ) + {ω}^{2} y + 2 ω {V}_{x} ,$$

$$and$$

$$\frac{{dV}_{z}}{dt} = \frac{- μ}{{r}^{3}} z - \frac{3}{2} {J}_{0}^{2} \frac{μ {a}^{2}}{{r}^{5}} z ( 1 - \frac{5 {z}^{2}}{{r}^{2}} ) .$$

Where μ is the gravitational constant, @ is the Earth rotation rate, α is the semi-major axis of Earth, and J is second zonal harmonic geopotential. These equations (2) and (3) offer a gravitational model of the LEO satellite that can offer sufficient accuracy for many circumstances. According to some embodiments, the validity provided by these equations may extend over tens of seconds because integration errors are usually negligible over this amount of time. According to some embodiments, an acceleration adjustment term may be added to one or more of the equations (3) (e.g., modeling gravitational perturbation and/or atmospheric drag) to help extend this validity. According to some embodiments, a server-based environment (e.g., as shown in FIG. 4B) may utilize an acceleration adjustment term to extend a validity period for PVT information of an LEO satellite, which it can provide to one or more mobile devices, for several minutes.

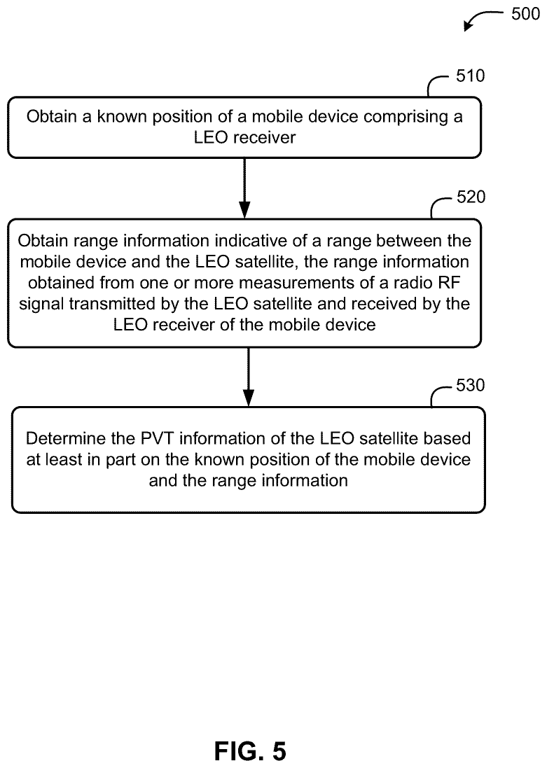

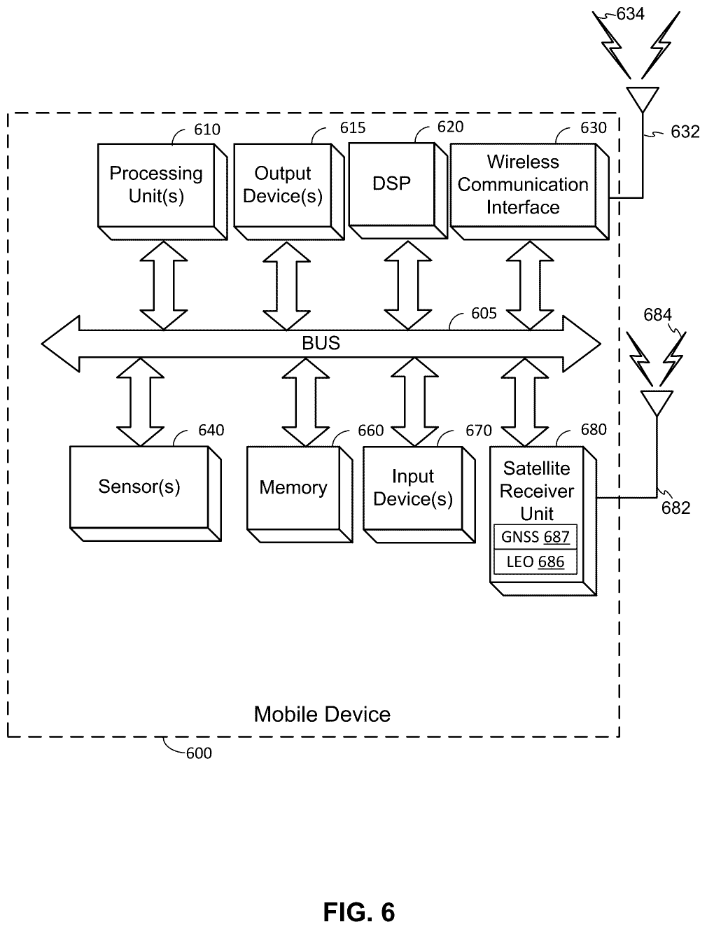

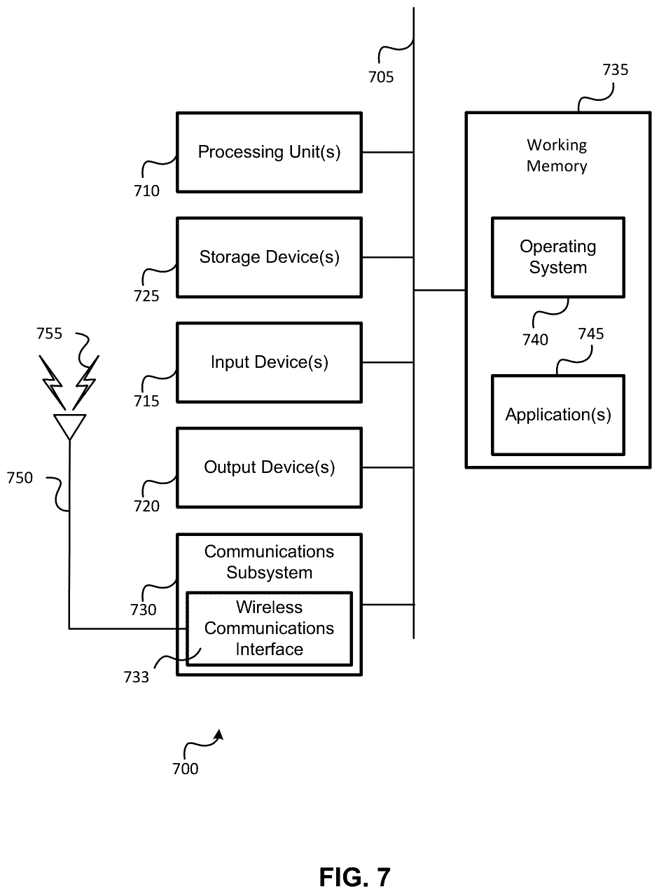

FIG. 5 is a flow diagram of a method 500 of determining PVT information of an LEO satellite for LEO-based positioning, according to an embodiment. Means for performing the functionality illustrated in one or more of the blocks shown in FIG. 5 may comprise hardware and/or software components of a mobile device and/or server. Example components of a mobile device are illustrated in FIG. 6 and example components of a server are illustrated in FIG. 7, both of which are described in more detail hereafter.

At block 510, the functionality comprises obtaining a known position of a mobile device comprising an LEO receiver. As previously described (e.g., with reference to FIG. 3) a mobile device may comprise any of a variety of device types, including a vehicle, vessel, electronic device, etc. As further noted, obtaining a known position of the mobile device may comprise obtaining a position of the mobile device as determined using one or more positioning techniques, such as GNSS positioning, wireless network-based positioning, sensor-based positioning, dead reckoning, or the like. If the functionality at block 510 is performed by the mobile device, obtaining the known position may comprise using one or more positioning techniques to determine the known position. If the functionality at block 510 is performed by a server or other device, obtaining the known position may comprise receiving the known position from the mobile device. Further, according to some embodiments, to receive the known position from the mobile device, a server or other device may first send a request for the known position to the mobile device.

Means for performing the functionality at block 510 may therefore comprise bus 605, processing unit(s) 610, wireless communication interface 630, sensor(s) 640, memory 660, satellite receiver unit 680, and/or other components of a mobile device, as illustrated in FIG. 6. Additionally or alternatively, means for performing the functionality at block 510 may therefore comprise bus 705, processing unit(s) 710, communications subsystem 730, working memory 735, and/or other components of a server, as illustrated in FIG. 7.

At block 520, the functionality comprises obtaining range information indicative of a range between the mobile device and the LEO satellite, the range information obtained from one or more measurements of a RF signal transmitted by the LEO satellite and received by the LEO receiver of the mobile device. As previously indicated, range information may include measurements of the range and (optionally) range rates between the mobile device and LEO satellite. According to some embodiments, measurements of a range rate may be based on a determination of a frequency offset, and measurement of a range may comprise pseudo-range measurements based on measuring the receipt of a pseudorandom sequence in a manner similar to GPS and other GNSS-based solutions.

Means for performing the functionality at block 520 may therefore comprise bus 605, processing unit(s) 610, wireless communication interface 630, sensor(s) 640, memory 660, satellite receiver unit 680, and/or other components of a mobile device, as illustrated in FIG. 6. Additionally or alternatively, means for performing the functionality at block 520 may therefore comprise bus 705, processing unit(s) 710, communications subsystem 730, working memory 735, and/or other components of a server, as illustrated in FIG. 7.

At block 530, the functionality comprises determining the PVT information of the LEO satellite based at least in part on the known position of the mobile device and the range information. As noted, the determination may be performed by the server or a mobile device. For example, according to some embodiments of the method 500, determining the PVT information of the LEO satellite maybe performed by a server communicatively linked to the mobile device, obtaining the known position of the mobile device may comprise receiving the known position at the server from the mobile device, and obtaining the range information may comprise receiving the range information at the server from the mobile device. In such embodiments, determining the PVT information of the LEO satellite additionally may be based on one or more additional known position of one or more additional mobile devices and, for each of the one or more additional mobile devices, information indicative of a range between the respective mobile device and the LEO satellite. Further, according to some embodiments, the method 500 may comprise sending the PVT information of the LEO satellite to the mobile device, at least one of the one or more additional mobile devices, or a combination thereof.

The functionality may be different if the determination of the PVT information is performed by the mobile device. For example, according to some of the method 500 determining the PVT information of the LEO satellite may be performed by the mobile device, and obtaining the range information may comprise taking the one or more measurements at the mobile device. As noted, these measurements may be indicative of a range and (optionally) range rate between the mobile device and LEO satellite. Moreover, as noted in relation to FIGS. 4A and 4B, measurements from other mobile device may be used. Thus, according to some embodiments, determining the PVT information of the LEO satellite further may be based on additional information comprising, for each of one or more additional mobile devices, information indicative of a range between the respective mobile device and the LEO satellite. According to some embodiments, the method 500 may comprise receiving the additional information at the mobile device from the one or more additional mobile devices, a server, or both.

As noted, determining PVT information at a mobile device can be beneficial during periods of time in which other positioning methods may be unavailable, such as during periods of time in which the mobile device is in GNSS degraded or denied environments. According to some embodiments, determining the PVT information of the LEO satellite may be performed by the mobile device at a first time, and the method 500 may further comprise determining a position of the mobile device at a second time, subsequent to the first time, based at least in part on the PVT information.

As noted, a mobile device may share PVT and/or range information to one or more other devices. As such, according to some embodiments, the method 500 may further comprise sending the PVT information of the LEO satellite, the range information, or both to a second mobile device. According to some embodiments, the sending of the PVT information of the LEO satellite, the range information, or both may be responsive to a request from the second mobile device. According to some embodiments, the sending of the PVT information of the LEO satellite, the range information, or both may be responsive to a determination that the LEO satellite is visible to the second mobile device. As noted, the mobile device may determine what is visible to the second mobile device based on, for example, a location (e.g., approximately location) of the second mobile device and an almanac, database, or other source of information indicative of satellite orbital information. According to some embodiments, the PVT information of the LEO satellite comprises a 3D position and velocity of the LEO satellite at a point in time.

Means for performing the functionality at block 530 may comprise bus 605, processing unit(s) 610, wireless communication interface 630, sensor(s) 640, memory 660, and/or other components of a mobile device, as illustrated in FIG. 6. Additionally or alternatively, means for performing the functionality at block 530 may therefore comprise bus 705, processing unit(s) 710, communications subsystem 730, working memory 735, and/or other components of a server, as illustrated in FIG. 7.

FIG. 6 illustrates an embodiment of a mobile device 600, which can be utilized as described herein above (e.g., in association with FIGS. 1-5). For example, the mobile device 600 can perform one or more of the functions of the method shown in FIG. 5. It should be noted that FIG. 6 is meant only to provide a generalized illustration of various components, any or all of which may be utilized as appropriate. It can be noted that, in some instances, components illustrated by FIG. 6 can be localized to a single physical device and/or distributed among various networked devices, which may be disposed at different physical locations (e.g., different physical locations on a vehicle or vessel). Furthermore, as previously noted, the functionality of the mobile device discussed in the previously described embodiments may be executed by one or more of the hardware and/or software components illustrated in FIG. 6.

The mobile device 600 is shown comprising hardware elements that can be electrically coupled via a bus 605 (or may otherwise be in communication, as appropriate). The hardware elements may include a processing unit(s) 610 which can include without limitation one or more general-purpose processors, one or more special-purpose processors (such as digital signal processor (DSP) chips, graphics acceleration processors, application specific integrated circuits (ASICs), and/or the like), and/or other processing structures or means. As shown in FIG. 6, some embodiments may have a separate DSP 620, depending on desired functionality. Location determination and/or other determinations based on wireless communication may be provided in the processing unit(s) 610 and/or wireless communication interface 630 (discussed below). The mobile device 600 also can include one or more input devices 670, which can include without limitation one or more keyboards, touch screens, touch pads, microphones, buttons, dials, switches, and/or the like; and one or more output devices 615, which can include without limitation one or more displays (e.g., touch screens), light emitting diodes (LEDs), speakers, and/or the like.

The mobile device 600 may also include a wireless communication interface 630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile device 600 to communicate with other devices as described in the embodiments above. The wireless communication interface 630 may permit data and signaling to be communicated (e.g., transmitted and received) with base stations or Transmission Reception Points (TRPs) of a network, for example, via eNBs, gNBs, ng-eNBs, access points, various base stations and/or other access node types, and/or other network components, computer systems, and/or any other electronic devices communicatively coupled with the network. The communication can be carried out via one or more wireless communication antenna(s) 632 that send and/or receive wireless signals 634. According to some embodiments, the wireless communication antenna(s) 632 may comprise a plurality of discrete antennas, antenna arrays, or any combination thereof. The antenna(s) 632 may be capable of transmitting and receiving wireless signals using beams (e.g., Tx beams and Rx beams). Beam formation may be performed using digital and/or analog beam formation techniques, with respective digital and/or analog circuitry. The wireless communication interface 630 may include such circuitry.

Depending on desired functionality, the wireless communication interface 630 may comprise a separate receiver and transmitter, or any combination of transceivers, transmitters, and/or receivers to communicate with base stations (e.g., ng-eNBs and gNBs) and other terrestrial transceivers, such as wireless devices and access points. The mobile device 600 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, Wideband Code Division Multiple Access (WCDMA), and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A WLAN may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 600 can further include sensor(s) 640. Sensor(s) 640 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the mobile device 600 may also include a satellite receiver unit 680 capable of receiving signals 684 from one or more satellites using an antenna 682 (which could be the same as antenna 632). In particular, the satellite receiver unit 680 may comprise an LEO receiver 686 and the GNSS receiver 687, as described herein. It can be noted that the LEO receiver 686 and GNSS receiver 687 may share components such as the antenna 682 and/or may have separate (e.g., specialized) components for processing signals from LEO or GNSS satellites. This may include, for example, processors and/or other circuitry capable of executing positioning engines (e.g., an EKF-based or WLS-based SPE and/or PPE) used to determine the positions of the mobile device and one or more LEO satellites. In some embodiments LEO receiver 686 and the GNSS receiver 687 may be separate components (e.g., not part of a larger satellite receiver unit 680).

As noted, positioning based on GNSS signal measurement can be utilized to complement and/or incorporate the techniques described herein. The GNSS receiver 687 can extract a position of the mobile device 600, using conventional techniques, from GNSS satellites X110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 687 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although satellite receiver unit 680 is illustrated in FIG. 6 as a distinct component, embodiments are not so limited. As used herein, the terms “satellite receiver,” “LEO receiver,” and “GNSS receiver” (and derivatives) may comprise hardware and/or software components configured to obtain measurements from satellites (e.g., LEO or GNSS). In some embodiments, therefore, the satellite receiver unit 680 may comprise a measurement engine executed (as software) by one or more processing units, such as processing unit(s) 610, DSP 620, and/or a processing unit within the wireless communication interface 630 (e.g., in a modem). As further noted, a satellite receiver may optionally also include a positioning engine, which can use satellite measurements from the measurement engine to determine a position of the mobile device 600. The positioning engine may also be executed by one or more processing units, such as processing unit(s) 610 or DSP 620.

The mobile device 600 may further include and/or be in communication with a memory 660. The memory 660 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 660 of the mobile device 600 also can comprise software elements (not shown in FIG. 6), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 660 that are executable by the mobile device 600 (and/or processing unit(s) 610 or DSP 620 within mobile device 600). In some embodiments, then, such code and/or instructions can be used to configure and/or adapt a general-purpose computer (or other device) to perform one or more operations in accordance with the described methods.

FIG. 7 is a block diagram of an embodiment of a computer system 700, which may be used, in whole or in part, to provide the functions of a server or satellite as described in the embodiments herein (e.g., location server 430 of FIG. 4B). It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different geographical locations.

The computer system 700 is shown comprising hardware elements that can be electrically coupled via a bus 705 (or may otherwise be in communication, as appropriate). The hardware elements may include processing unit(s) 710, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 700 also may comprise one or more input devices 715, which may comprise without limitation a mouse, a keyboard, a camera, a microphone, and/or the like; and one or more output devices 720, which may comprise without limitation a display device, a printer, and/or the like.

The computer system 700 may further include (and/or be in communication with) one or more non-transitory storage devices 725, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 700 may also include a communications subsystem 730, which may comprise wireless communication technologies managed and controlled by a wireless communication interface 733, as well as wired technologies (such as Ethernet, coaxial communications, universal serial bus (USB), and the like). The wireless communication interface 733 may comprise one or more wireless transceivers may send and receive wireless signals 755 (e.g., signals according to 5G NR, LTE, or Wi-Fi) via wireless antenna(s) 750. Thus the communications subsystem 730 may comprise a modem, a network card (wireless or wired), an infrared communication device, a wireless communication device, and/or a chipset, and/or the like, which may enable the computer system 700 to communicate on any or all of the communication networks described herein to any device on the respective network, including a User Equipment (UE), base stations and/or other TRPs, and/or any other electronic devices described herein. Hence, the communications subsystem 730 may be used to receive and send data as described in the embodiments herein.

In many embodiments, the computer system 700 will further comprise a working memory 735, which may comprise a RAM or ROM device, as described above. Software elements, shown as being located within the working memory 735, may comprise an operating system 740, device drivers, executable libraries, and/or other code, such as one or more applications 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A method of determining Position, Velocity, and Time (PVT) information of a Low-Earth Orbit (LEO) satellite for LEO-based positioning, the method comprising: obtaining a known position of a mobile device comprising a LEO receiver; obtaining range information indicative of a range between the mobile device and the LEO satellite, the range information obtained from one or more measurements of a radio frequency (RF) signal transmitted by the LEO satellite and received by the LEO receiver of the mobile device; and determining the PVT information of the LEO satellite based at least in part on the known position of the mobile device and the range information.
Clause 2. The method of clause 1, wherein: determining the PVT information of the LEO satellite is performed by a server communicatively linked to the mobile device; obtaining the known position of the mobile device comprises receiving the known position at the server from the mobile device; and obtaining the range information comprises receiving the range information at the server from the mobile device.
Clause 3. The method of any of clauses 1-2 wherein determining the PVT information of the LEO satellite is additionally based on one or more additional known positions of one or more additional mobile devices and, for each of the one or more additional mobile devices, information indicative of a range between the respective mobile device and the LEO satellite.
Clause 4. The method of any of clauses 1-3 further comprising sending the PVT information of the LEO satellite to: the mobile device, at least one of the one or more additional mobile devices, or a combination thereof.
Clause 5. The method of clause 1 wherein determining the PVT information of the LEO satellite is performed by the mobile device; and obtaining the range information comprises taking the one or more measurements at the mobile device.
Clause 6. The method of any of clauses 1 and 5 wherein determining the PVT information of the LEO satellite is further based on additional information comprising, for each of one or more additional mobile devices, information indicative of a range between the respective mobile device and the LEO satellite.
Clause 7. The method of any of clauses 1 and 5-6 further comprising receiving the additional information at the mobile device from the one or more additional mobile devices, a server, or both.
Clause 8. The method of any of clauses 1 and 5-7 wherein determining the PVT information of the LEO satellite is performed by the mobile device at a first time; and the method further comprises determining a position of the mobile device at a second time, subsequent to the first time, based at least in part on the PVT information.
Clause 9. The method of any of clauses 1-8 further comprising sending the PVT information of the LEO satellite, the range information, or both to a second mobile device.
Clause 10. The method of clause 9 wherein the sending of the PVT information of the LEO satellite, the range information, or both is responsive to a request from the second mobile device.
Clause 11. The method of clause 9 wherein the sending of the PVT information of the LEO satellite, the range information, or both is responsive to a determination that the LEO satellite is visible to the second mobile device.
Clause 12. The method of any of clauses 1-11 wherein the PVT information of the LEO satellite comprises a 3D position and velocity of the LEO satellite at a point in time.
Clause 13. A device for determining Position, Velocity, and Time (PVT) information of a Low-Earth Orbit (LEO) satellite for LEO-based positioning, the device comprising: a transceiver; a memory; and one or more processors communicatively coupled with the transceiver and the memory, wherein the one or more processors are configured to: obtain a known position of a mobile device comprising a LEO receiver; obtain range information indicative of a range between the mobile device and the LEO satellite, the range information obtained from one or more measurements of a radio frequency (RF) signal transmitted by the LEO satellite and received by the LEO receiver of the mobile device; and determine the PVT information of the LEO satellite based at least in part on the known position of the mobile device and the range information.
Clause 14. The device of clause 13, wherein the device comprises a server communicatively linked to the mobile device, and wherein: to obtain the known position of the mobile device, the one or more processors are configured to receive the known position from the mobile device via the transceiver; and to obtain the range information, the one or more processors are configured to receive the range information at the server from the mobile device via the transceiver.
Clause 15. The device of any of clauses 13-14 wherein the one or more processors are configured to determine the PVT information of the LEO satellite additionally based on one or more additional known positions of one or more additional mobile devices and, for each of the one or more additional mobile devices, information indicative of a range between the respective mobile device and the LEO satellite.
Clause 16. The device of any of clauses 13-15 wherein the one or more processors are further configured to send the PVT information of the LEO satellite, via the transceiver, to: the mobile device, at least one of the one or more additional mobile devices, or a combination thereof.
Clause 17. The device of any of clause 13 wherein the device comprises the mobile device, and, to obtain the range information, the one or more processors are configured to take the one or more measurements.
Clause 18. The device of any of clauses 13 and 17 wherein the one or more processors are configured to determine the PVT information of the LEO satellite further based on additional information comprising, for each of one or more additional mobile devices, information indicative of a range between the respective mobile device and the LEO satellite.
Clause 19. The device of any of clauses 13, 17, and 18 wherein the one or more processors are further configured to receive the additional information, via the transceiver, from the one or more additional mobile devices, a server, or both.
Clause 20. The device of any of clauses 13 and 17-19 wherein the one or more processors are further configured to: determine the PVT information of the LEO satellite at a first time; and determine a position of the mobile device at a second time, subsequent to the first time, based at least in part on the PVT information.
Clause 21. The device of any of clauses 13-20 wherein the one or more processors are further configured to send the PVT information of the LEO satellite, the range information, or both to a second mobile device via the transceiver.
Clause 22. The device of clause 21 wherein the one or more processors are configured to perform the sending of the PVT information of the LEO satellite, the range information, or both in response to a request from the second mobile device.
Clause 23. The device of clause 21 wherein the one or more processors are configured to perform the sending of the PVT information of the LEO satellite, the range information, or both in response to a determination that the LEO satellite is visible to the second mobile device.
Clause 24. The device of any of clauses 13-23 wherein, to determine the PVT information of the LEO satellite, the one or more processors are further configured to determine a 3D position and velocity of the LEO satellite at a point in time.
Clause 25. An apparatus for determining Position, Velocity, and Time (PVT) information of a Low-Earth Orbit (LEO) satellite for LEO-based positioning, the apparatus comprising: means for obtaining a known position of a mobile device comprising a LEO receiver; means for obtaining range information indicative of a range between the mobile device and the LEO satellite, the range information obtained from one or more measurements of a radio frequency (RF) signal transmitted by the LEO satellite and received by the LEO receiver of the mobile device; and means for determining the PVT information of the LEO satellite based at least in part on the known position of the mobile device and the range information.
Clause 26. The apparatus of clause 25, wherein the apparatus comprises a server communicatively linked to the mobile device, and wherein: the means for obtaining the known position of the mobile device comprises means for receiving the known position at the server from the mobile device; and the means for obtaining the range information comprises means for receiving the range information at the server from the mobile device.
Clause 27. The apparatus of any of clauses 25-26 further comprising means for determining the PVT information of the LEO satellite additionally based on one or more additional known positions of one or more additional mobile devices and, for each of the one or more additional mobile devices, information indicative of a range between the respective mobile device and the LEO satellite.
Clause 28. The apparatus of any of clauses 25-27 further comprising means for sending the PVT information of the LEO satellite to: the mobile device, at least one of the one or more additional mobile devices, or a combination thereof.
Clause 29. The apparatus of clause 25 wherein the apparatus comprises the mobile device; and the means for obtaining the range information comprises means for taking the one or more measurements at the mobile device.
Clause 30. The apparatus of clause 25 and 29 further comprising means for determining the PVT information of the LEO satellite further based on additional information comprising, for each of one or more additional mobile devices, information indicative of a range between the respective mobile device and the LEO satellite.
Clause 31. The apparatus of any of clauses 25 and 29-30 further comprising means for receiving the additional information at the mobile device from the one or more additional mobile devices, a server, or both.
Clause 32. The apparatus of any of clauses 25 and 29-31 wherein the means for determining the PVT information of the LEO satellite comprise means for determining the PVT information of the LEO satellite at a first time; and the apparatus further comprises means for determining a position of the mobile device at a second time, subsequent to the first time, based at least in part on the PVT information.
Clause 33. The apparatus of any of clauses 25-32 further comprising means for sending the PVT information of the LEO satellite, the range information, or both to a second mobile device.
Clause 34. The apparatus of clause 33 wherein further comprising means for performing the sending the PVT information of the LEO satellite, the range information, or both in response to a request from the second mobile device.
Clause 35. The apparatus of clause 33 wherein further comprising means for performing the sending the PVT information of the LEO satellite, the range information, or both in response to a determination that the LEO satellite is visible to the second mobile device.
Clause 36. The apparatus of any of clauses 25-35 wherein the means for determining the PVT information of the LEO satellite comprises means for determining a 3D position and velocity of the LEO satellite at a point in time.
Clause 37. A non-transitory computer-readable medium storing instructions for determining Position, Velocity, and Time (PVT) information of a Low-Earth Orbit (LEO) satellite for LEO-based positioning, the instructions comprising code for: obtaining a known position of a mobile device comprising a LEO receiver; obtaining range information indicative of a range between the mobile device and the LEO satellite, the range information obtained from one or more measurements of a radio frequency (RF) signal transmitted by the LEO satellite and received by the LEO receiver of the mobile device; and determining the PVT information of the LEO satellite based at least in part on the known position of the mobile device and the range information.
Clause 38. The computer-readable medium of clause 37, wherein: the code for determining the PVT information of the LEO satellite comprises the code for determining the PVT information of the LEO satellite at a server communicatively linked to the mobile device; the code for obtaining the known position of the mobile device comprises code for receiving the known position at the server from the mobile device; and the code for obtaining the range information comprises code for receiving the range information at the server from the mobile device.
Clause 39. The computer-readable medium of any of clauses 37-38 wherein the code for determining the PVT information of the LEO satellite comprises code for determining the PVT information of the LEO satellite additionally based on one or more additional known positions of one or more additional mobile devices and, for each of the one or more additional mobile devices, information indicative of a range between the respective mobile device and the LEO satellite.
Clause 40. The computer-readable medium of any of clauses 37-39 wherein the instructions further comprise code for sending the PVT information of the LEO satellite to: the mobile device, at least one of the one or more additional mobile devices, or a combination thereof.
Clause 41. The computer-readable medium of clause 37 wherein the code for determining the PVT information of the LEO satellite comprises the code for determining the PVT information of the LEO satellite by the mobile device; and the code for obtaining the range information comprises code for taking the one or more measurements at the mobile device.
Clause 42. The computer-readable medium of any of clauses 37 and 41 wherein the code for determining the PVT information of the LEO satellite comprises code for determining the PVT information of the LEO satellite further based on additional information comprising, for each of one or more additional mobile devices, information indicative of a range between the respective mobile device and the LEO satellite.
Clause 43. The computer-readable medium of any of clauses 37 and 41-42 wherein the instructions further comprise code for receiving the additional information at the mobile device from the one or more additional mobile devices, a server, or both.
Clause 44. The computer-readable medium of any of clauses 37 and 41-43 wherein the code for determining the PVT information of the LEO satellite comprises code for determining the PVT information of the LEO satellite at a first time; and the instructions further comprise code for determining a position of the mobile device at a second time, subsequent to the first time, based at least in part on the PVT information.
Clause 45. The computer-readable medium of any of clauses 37-44 wherein the instructions further comprise code for sending the PVT information of the LEO satellite, the range information, or both to a second mobile device.
Clause 46. The computer-readable medium of clause 45 wherein the instructions further comprise code for performing the sending of the PVT information of the LEO satellite, the range information, or both in response to a request from the second mobile device.
Clause 47. The computer-readable medium of clause 45 wherein the instructions further comprise code for performing the sending of the PVT information of the LEO satellite, the range information, or both in response to a determination that the LEO satellite is visible to the second mobile device.
Clause 48. The computer-readable medium of any of clauses 37-47 wherein the code for determining the PVT information of the LEO satellite comprises code for determining a 3D position and velocity of the LEO satellite at a point in time.

1. A method of determining Position, Velocity, and Time (PVT) information of a Low-Earth Orbit (LEO) satellite for LEO-based positioning, the method comprising:
obtaining a known position of a mobile device comprising a LEO receiver;
obtaining range information indicative of a range between the mobile device and the LEO satellite, the range information obtained from one or more measurements of a radio frequency (RF) signal transmitted by the LEO satellite and received by the LEO receiver of the mobile device; and
determining the PVT information of the LEO satellite based at least in part on the known position of the mobile device and the range information.

2. The method of claim 1, wherein:
determining the PVT information of the LEO satellite is performed by a server communicatively linked to the mobile device;
obtaining the known position of the mobile device comprises receiving the known position at the server from the mobile device; and
obtaining the range information comprises receiving the range information at the server from the mobile device.

3. The method of claim 2, wherein determining the PVT information of the LEO satellite is additionally based on one or more additional known positions of one or more additional mobile devices and, for each of the one or more additional mobile devices, information indicative of a range between the respective mobile device and the LEO satellite.

4. The method of claim 3, further comprising sending the PVT information of the LEO satellite to:
the mobile device,
at least one of the one or more additional mobile devices, or
a combination thereof.

5. The method of claim 1, wherein
determining the PVT information of the LEO satellite is performed by the mobile device; and
obtaining the range information comprises taking the one or more measurements at the mobile device.

6. The method of claim 5, wherein determining the PVT information of the LEO satellite is further based on additional information comprising, for each of one or more additional mobile devices, information indicative of a range between the respective mobile device and the LEO satellite.

7. The method of claim 6, further comprising receiving the additional information at the mobile device from the one or more additional mobile devices, a server, or both.

8. The method of claim 5, wherein:
determining the PVT information of the LEO satellite is performed by the mobile device at a first time; and
the method further comprises determining a position of the mobile device at a second time, subsequent to the first time, based at least in part on the PVT information.

9. The method of claim 1, further comprising sending the PVT information of the LEO satellite, the range information, or both to a second mobile device.

10. The method of claim 9, wherein the sending of the PVT information of the LEO satellite, the range information, or both is responsive to a request from the second mobile device.

11. The method of claim 9, wherein the sending of the PVT information of the LEO satellite, the range information, or both is responsive to a determination that the LEO satellite is visible to the second mobile device.

12. The method of claim 1, wherein the PVT information of the LEO satellite comprises a 3D position and velocity of the LEO satellite at a point in time.

13. A device for determining Position, Velocity, and Time (PVT) information of a Low-Earth Orbit (LEO) satellite for LEO-based positioning, the device comprising:
a transceiver;
a memory; and
one or more processors communicatively coupled with the transceiver and the memory, wherein the one or more processors are configured to:
obtain a known position of a mobile device comprising a LEO receiver;
obtain range information indicative of a range between the mobile device and the LEO satellite, the range information obtained from one or more measurements of a radio frequency (RF) signal transmitted by the LEO satellite and received by the LEO receiver of the mobile device; and
determine the PVT information of the LEO satellite based at least in part on the known position of the mobile device and the range information.

14. The device of claim 13, wherein the device comprises a server communicatively linked to the mobile device, and wherein:
to obtain the known position of the mobile device, the one or more processors are configured to receive the known position from the mobile device via the transceiver; and
to obtain the range information, the one or more processors are configured to receive the range information at the server from the mobile device via the transceiver.

15. The device of claim 14, wherein the one or more processors are configured to determine the PVT information of the LEO satellite additionally based on one or more additional known positions of one or more additional mobile devices and, for each of the one or more additional mobile devices, information indicative of a range between the respective mobile device and the LEO satellite.

16. The device of claim 15, wherein the one or more processors are further configured to send the PVT information of the LEO satellite, via the transceiver, to:
the mobile device,
at least one of the one or more additional mobile devices, or
a combination thereof.

17. The device of claim 13, wherein the device comprises the mobile device, and, to obtain the range information, the one or more processors are configured to take the one or more measurements.

18. The device of claim 17, wherein the one or more processors are configured to determine the PVT information of the LEO satellite further based on additional information comprising, for each of one or more additional mobile devices, information indicative of a range between the respective mobile device and the LEO satellite.

19. The device of claim 18, wherein the one or more processors are further configured to receive the additional information, via the transceiver, from the one or more additional mobile devices, a server, or both.

20. The device of claim 17, wherein the one or more processors are further configured to:
determine the PVT information of the LEO satellite at a first time; and
determine a position of the mobile device at a second time, subsequent to the first time, based at least in part on the PVT information.

21. The device of claim 13, wherein the one or more processors are further configured to send the PVT information of the LEO satellite, the range information, or both to a second mobile device via the transceiver.

22. The device of claim 21, wherein the one or more processors are configured to perform the sending of the PVT information of the LEO satellite, the range information, or both in response to a request from the second mobile device.

23. The device of claim 21, wherein the one or more processors are configured to perform the sending of the PVT information of the LEO satellite, the range information, or both in response to a determination that the LEO satellite is visible to the second mobile device.

24. The device of claim 13, wherein, to determine the PVT information of the LEO satellite, the one or more processors are further configured to determine a 3D position and velocity of the LEO satellite at a point in time.

25. An apparatus for determining Position, Velocity, and Time (PVT) information of a Low-Earth Orbit (LEO) satellite for LEO-based positioning, the apparatus comprising:
means for obtaining a known position of a mobile device comprising a LEO receiver;
means for obtaining range information indicative of a range between the mobile device and the LEO satellite, the range information obtained from one or more measurements of a radio frequency (RF) signal transmitted by the LEO satellite and received by the LEO receiver of the mobile device; and
means for determining the PVT information of the LEO satellite based at least in part on the known position of the mobile device and the range information.

26. The apparatus of claim 25, wherein the apparatus comprises a server communicatively linked to the mobile device, and wherein:
the means for obtaining the known position of the mobile device comprises means for receiving the known position at the server from the mobile device; and
the means for obtaining the range information comprises means for receiving the range information at the server from the mobile device.

27. The apparatus of claim 26, further comprising means for determining the PVT information of the LEO satellite additionally based on one or more additional known positions of one or more additional mobile devices and, for each of the one or more additional mobile devices, information indicative of a range between the respective mobile device and the LEO satellite.

28. The apparatus of claim 27, further comprising means for sending the PVT information of the LEO satellite to:
the mobile device,
at least one of the one or more additional mobile devices, or
a combination thereof.

29. The apparatus of claim 25, wherein the apparatus comprises the mobile device; and
the means for obtaining the range information comprises means for taking the one or more measurements at the mobile device.

30. The apparatus of claim 29, further comprising means for determining the PVT information of the LEO satellite further based on additional information comprising, for each of one or more additional mobile devices, information indicative of a range between the respective mobile device and the LEO satellite.

31. The apparatus of claim 30, further comprising means for receiving the additional information at the mobile device from the one or more additional mobile devices, a server, or both.

32. The apparatus of claim 29, wherein:
the means for determining the PVT information of the LEO satellite comprise means for determining the PVT information of the LEO satellite at a first time; and
the apparatus further comprises means for determining a position of the mobile device at a second time, subsequent to the first time, based at least in part on the PVT information.

33. The apparatus of claim 25, further comprising means for sending the PVT information of the LEO satellite, the range information, or both to a second mobile device.

34. The apparatus of claim 33, wherein further comprising means for performing the sending the PVT information of the LEO satellite, the range information, or both in response to a request from the second mobile device.

35. The apparatus of claim 33, wherein further comprising means for performing the sending the PVT information of the LEO satellite, the range information, or both in response to a determination that the LEO satellite is visible to the second mobile device.

36. The apparatus of claim 25, wherein the means for determining the PVT information of the LEO satellite comprises means for determining a 3D position and velocity of the LEO satellite at a point in time.

37. A non-transitory computer-readable medium storing instructions for determining Position, Velocity, and Time (PVT) information of a Low-Earth Orbit (LEO) satellite for LEO-based positioning, the instructions comprising code for:
obtaining a known position of a mobile device comprising a LEO receiver;
obtaining range information indicative of a range between the mobile device and the LEO satellite, the range information obtained from one or more measurements of a radio frequency (RF) signal transmitted by the LEO satellite and received by the LEO receiver of the mobile device; and
determining the PVT information of the LEO satellite based at least in part on the known position of the mobile device and the range information.
